(19) United States
(12) Patent Application Publication
(10) Pub. No.: US 2009/0240736 A1
(43) Pub. Date: Sep. 24, 2009

(54) Method and System for Creating a Personalized Multimedia Production

(76) Inventor: James Crist, Buffalo, NY (US)

Correspondence Address: LAW OFFICE OF TRACY P. JONG, 2775 BUFFALO ROAD, SUITE 3, ROCHESTER, NY, 14624, US

(21) Appl. No.: 12/409,628

(22) Filed: Mar. 24, 2009

Related U.S. Application Data
(60) Provisional application No. 61/039,068, filed on Mar. 24, 2008.

(51) Int. Cl. G06F 17/30

(52) U.S. Cl. 707/104.1; 707/E17.009

(57) ABSTRACT

This invention provides an Information Content Processing Device comprising a system of hardware and software, together with a method, for personalizing prerecorded text, pictures, video, and/or audio media with unfinished segments. The prerecorded media is personalized with personal content media to produce a final multimedia production in digital format for storage on a storage device. Because of the multitude of possible file formats associated with a multimedia production, an Expert Media Facility communication link exists to assist the user in its creation.

### CROSS REFERENCE TO RELATED APPLICATIONS AND PRIORITY CLAIM

This application claims priority to U.S. Ser. No. 61/039,068, a provisional application filed by James Crist on Mar. 24, 2008.

### FIELD OF THE INVENTION

This invention generally relates to multimedia production, and in particular, to an Information Content Process Device and method for personalizing and combining prerecorded text, graphics, pictures, video, audio media, and the like into a user designed multimedia production. The prerecorded media is personalized with one or more prerecorded, contemporaneously input or captured graphic, video, text, animated and/or audio media data with the user's personal content. Because of the multitude of possible file formats associated with a multimedia production, an Expert Media Facility communication link exists to assist the user in its creation.

### BACKGROUND OF THE INVENTION

Years ago, consumers had only the option of purchasing media (e.g., vinyl records, audio cassette tapes, CDs, DVDs, etc.) with a manufacturer/producer selected list of songs. If you wanted a custom mix, you could “dub” cassette tapes, that is, record from the prerecorded media to a blank tape. Custom play lists might also be created by programming a CD changer with one or more CDs. Today, media is consumed in a different manner.

Consumers increasingly demand customized media products. The introduction of electronic products such as smart phones, DVRs, MP3 players, MP4 players, iPods® and other digital devices enable users to create custom “play lists” to play selected media. For example, a customized or personalized play list (audio or video) may be created from downloaded files from a plurality of artists. This has changed the way consumers purchase and use audio and video media, creating a new demand in the marketplace to accommodate the desire for personalized, custom products for the mass consumers.

Digital photography has also become available on a wide variety of low cost devices, increasing the consumer demand for creative ways to use these digital photographic images. Users similarly create “slideshows” with downloaded graphic files of still images or video data files, with the option of including audio files to play in the background during the slideshow. Multimedia files are shared not only with close friends and family, but have also become commonplace on publicly accessible websites such as Facebook™, YouTube™ and the many others that populate the internet.

However, a user requires a certain level of sophistication to create customized multimedia files. The required equipment to “burn” a CD, DVD, or other analog or digital file format, for example, can prove to be both complex and expensive, especially if computer upgrades are required. The associated software is likewise, both complex and expensive, rendering this genre unavailable to the mass consumer population.

U.S. Pat. No. 6,463,205 discloses an apparatus and method for creating customized video products. The video has certain prerecorded segments intermingled with customizable segments that are filled with captured video and/or audio segments such that a final product is produced with a seamless transition between the prerecorded and captured segments. This system and method is limited in that it does not allow for a further level of customization by the user. According to the U.S. Pat. No. 6,463,205 patent, during recording, the video moves sequentially from one customizable section to another automatically according to a predesignated edit list. Thus, a user is unable to intermix files and correlate related files together to play in a desired configuration. The user is also unable to control the order and transition between the prerecorded and customized portions of the final product. In addition, there isn't any provision for assistance regarding the complex issues associated with the multitude of possible file formats associated with the final product.

Thus, there remains a need for a system and method of creating personalized multimedia files that allows a user to mark or “tag” uploaded files in a manner that allows them to be sorted prior to inserting the files into a prerecorded sequence. There additionally remains a need for a system and method that provides a user more control over the selection and sequencing of the prerecorded and customized audio and video segments, as well as providing assistance regarding the complex issues associated with the multitude of possible file formats associated with the final product.

### SUMMARY OF THE INVENTION

In accordance with the present invention there is provided an Information Content Processing Device (ICPD) comprised of hardware and software for receiving personal content (e.g. personal photos, video clips, etc.), selected content (clipart, songs, downloadable material, and the like) and producing an output file in the form of a final multimedia production in a user selected format and media type (e.g. DVD, CD, Blu-ray Disk, flash drive, etc.). It is understood that format type in certain circumstances is dictated by the media type (e.g. DVD productions are constructed from an array of files that are in VOB type format). If the final multimedia production is to be placed, for example, on a USB flash drive, to be played back on a computer, then there's more flexibility in selecting the format of the final file. In accordance with this invention, and one embodiment thereof, there is also provided a method comprising the steps of uploading or inputting personal content, storing digital data, accessing, categorizing or arranging the digital data, processing the digital data, outputting the processed digital data as a final multimedia production, and storing, outputting, or writing the final product in selected format on the desired media. The system and method may be embodied in an Information Content Processing Device (ICPD) that has a straightforward human interface to overcome the limitations of the complex editing software that traditionally produces a customized synchronized multimedia product. In one embodiment, styled as a kiosk, the ICPD includes the necessary components to produce a video cassette, CD, DVD, Blu-ray disk, digital book, digital video, paper book with audio or other multimedia product as an output. Additionally or alternatively, a plurality of ports or interfaces may be provided on the kiosk to enable a direct connection to a device for downloading a media data file to any internal or external storage device (portable computer, memory card, hard drive, smart phone, MP3 player, MP4 player, iPod®, USB memory stick, fire wire, media card, external hard drive, portable external memory device, and the like).

In one embodiment styled as a web interface, ICPS (Information Content Processing Software) would enable the output of a synchronized digital multimedia file that may be downloaded onto the desired playing and/or storage medium by the user. In yet another embodiment, ICPS may employ the method, allowing a personal computer to perform the personalizing and synchronizing tasks and creating the output product. All the aforementioned means of storage thus far shall be referred to as media. The term “user” in this disclosure shall be understood to include the ICPD facility and staff in addition to the individual(s) that initiated the request.

Accordingly, it is an object of the present invention to provide an improved system and method of creating personalized multimedia files that allows a user to mark or “tag” uploaded files in a manner that allows them to be sorted prior to inserting the files into a prerecorded sequence.

It is a further object of the present invention to provide a method and system that provides a user more control over the selection and sequencing of the prerecorded and customized audio and video segments of the final product.

It is an object of the present invention to provide a device that saves time and effort for a user when making personalized multimedia products.

It is yet an object of the present invention to provide real-time assistance regarding the problems that may arise during the process due to complex issues associated with the multitude of possible file formats, and the like.

It is yet an object of the present invention to provide the option of having a communications link, via a communications link, to a MEF (Media Expert Facility) with a Media Expert available. The MEF is an off-site, multifunctional facility that can provide a variety of services, for example, high speed processing of the individual files into the final multimedia composition, transmit the final file to the ICPD for writing onto chosen media, writing the final multimedia composition onto chosen media at the MEF (Media Expert Facility) location followed by shipping the final media product to the user, customer, etc.

Whereas there may be many embodiments of the present invention, each embodiment may meet one or more of the foregoing recited objects in any combination. It is not intended that each embodiment will necessarily meet each objective.

Thus, having broadly outlined the more important features of the present invention in order that the detailed description thereof may be better understood, and that the present contribution to the art may be better appreciated, there are, of course, additional features of the present invention that will be described herein and will form a part of the subject matter of the claims appended to this specification.

In this respect, before explaining at least one embodiment of the invention in detail, it is to be understood that the invention is not limited in its application to the details of construction and the arrangements of the components set forth in the following description or illustrated in the drawings. The present invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention.

### BRIEF DESCRIPTION OF THE DRAWINGS

The invention will be described by reference to the specification and the drawings, in which like numerals refer to like elements, and wherein:

FIG. 1 is a schematic representation (flowchart) of one embodiment of a computer process according to the present invention;

FIG. 2 is a schematic diagram (flowchart) depicting one embodiment of step 100 of FIG. 1;

FIG. 3 is a schematic diagram (flowchart) depicting one embodiment of step 400 of FIG. 1.

FIG. 4 is a schematic diagram (block diagram) depicting one embodiment of an Information Content Processing Device; and

FIG. 5 is a schematic diagram (block diagram) depicting an embodiment showing the relationships among the MEF, Media Expert, ICPD, Delivery Service, and the User.

### DEFINITIONS

User 528: A consumer, customer, or the like that has a vested interest in the multimedia production. The term “user” in this disclosure shall be understood to include the ICPD facility and staff in addition to the individual(s) that initiated the request.

Media Expert 504: One or more individuals that are well trained in the area of multimedia, multimedia file manipulation, and the like.

Final Multimedia Production: A file, typically constructed from two or more smaller individual files of different formats that has been organized, edited, and manipulated such that it meets User 528 requirements. The file at this level is ready to be written onto the media of choice (e.g. DVD, CD, Blu-ray disk, mp3 player, smartphone, etc.) via Media Creation Output 520 comprising CD/DVD/Blu-ray burners, download cables for common portable electronics (mp3 players, ipods, etc.), and the like. It is understood that the Final Multimedia Production file may have to undergo one or more conversions or transcoding steps prior to or during the writing, burning, or downloading process.

Information Content Processing Device (ICPD), 514: The device or system where the User 528 inputs, or obtains the individual media files, followed by organizing, editing, and manipulating the individual media files into a user defined composition. In its most complete form, it comprises Input/output devices 524, Display(s) 524, Media Input/output capability 522, and a Workstation 518. Depending on the aptitude of the user, the complexity of the Multimedia Production project, and the capability of the ICPD 514, a Final Multimedia Production can be created and written onto the media of choice via Media Creation Output 520 at the ICPD 514 site.

Media Expert Facility (MEF) 502: A system, connected to one or more ICPD 514 via a Communications Link 516, which possesses advanced multimedia capabilities compared to the ICPD 514. MEF 502 further includes a Media Expert 504 that can provide real time assistance to a User 528 located at an ICPD 514 site. The MEF 502 is capable of downloading any or all user files so as to “take over” the project when the project proves to be too complex for the user 528 and/or ICPD 514 system.

### DETAILED DESCRIPTION OF AN EMBODIMENT

According to the method of the present invention, a creator, user, or customer interactively creates and produces a personalized final multimedia production, in a multimedia format, utilizing an Information Content Processing Device (ICPD). As used in this specification, Information Content Processing Device (ICPD) means Information Content Processing Hardware (ICPH) that accesses Information Content Processing Software (ICPS). The Information Content Processing Hardware (ICPH) receives the input of personal content media files from the User and stores the personal content media files digitally. The ICPS accesses prerecorded and personal content data (collectively referred to as digital data), processes the digital data (thereby creating processed digital data), and outputs the processed digital data (final multimedia production) for either storage on the ICPD and/or on removable media.

As will be appreciated by those skilled in the art, the personal content media input files, as well as the ICPS's output files, may be in analog or digital format. The ICPH and/or ICPS may thus provide for conversion from analog data to digital data and the inverse, as necessary or desirable. As may be also appreciated by those skilled in the art, the ICPS and digital data may be stored locally or remotely. Remotely stored applications and digital data may be accessed by any known communications protocol and equipment (e.g., intranets, the internet, and the like). The personal content media may consist of data files containing text, audio, still images (e.g. photographs), animation, and/or video.

Utilizing the ICPH and ICPS, the User interacts with the ICPD to process the personal content digital data and the prerecorded digital data, to create a final multimedia production. User then selects the type and the format of the output file (the final multimedia production). The output file may be saved on the ICPD. The output file may be saved directly on a digital device with storage such as a digital camera, smart phone, PDA, ipod, MP3 player, MP4 player, and the like. Preferably, however, the output file is saved on removable media such as a CD, DVD, flash drive or media card.

The manipulation of multimedia files is filled with complexities such that the casual computer user would occasionally require assistance. One such troublesome area involves the multitude of possible file formats associated with a multimedia production. Each file must be recognized, read, manipulated (edited), and likely transcoded into the final format that's compatible with the media written upon and the electronic device on which it is to be played. A communication link, (preferably an ultra high speed connection) to an Expert Media Facility is provided to optionally assist the user upon request. The EMF (Expert Media Facility) comprises a computer, preferably a powerful workstation, superior to that of the ICPD, capable of high speed processing of the multimedia files. The EMF (Expert Media Facility) is under the direction of a Media Expert, an individual(s) that are well trained in the area of multimedia file manipulation.

Embodiments of the invention may be implemented as an ICPD (computing system or apparatus), an ICPD with MEF support, a computer process (method), or as an article of manufacture in the form of a computer program product.

As used in this specification, multimedia means the convergence of text, pictures, video and sound into a single form, or file format, and includes for example, a combination of text, audio, still images, animation, video, interactivity content forms, and the like. As used in this specification, multimedia production means an audio and/or visual artwork which may contain literary or visual artwork combined with audio, such as a digital book, digital video, slideshow or any other multimedia format.

As used in this specification, scene means a visual clip or combination of video clips that may or may not also contain audio clips. Each media clip may be an entire personal content digital data file or merely a part of a file. User may select a starting point and/or end point within a larger audio or video file, creating and saving the partial content or “sub-clip” as a new media clip. A media clip takes various forms including a text file (for captions or text-to-speech), an image or graphic file (for still pictures), a video file, an audio file or other media file type. Media clips are both static and dynamic type. For example, a text type file generally provides information statically while a video or audio file is dynamic providing a time dimension to the media clip.

### Computer Process

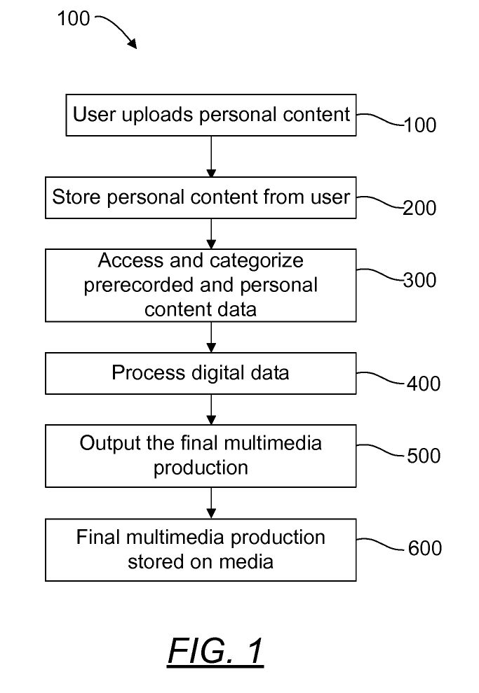

FIG. 1 is a schematic representation of one embodiment of a computer process according to the present invention. The computer process comprises six steps. Referring to FIG. 1 and step 100, personal content from the User is uploaded. Where necessary or desirable, analog data is converted to digital data. In step 200, uploaded digital data, consisting of the personal content from the User, is stored. In step 300, prerecorded and personal content data (collectively referred to as digital data) is accessed and categorized. In step 400, the digital data is processed (thereby creating processed digital data). In step 500, the processed digital data is outputted as the final multimedia production. In step 600, the final multimedia production is stored on the media of choice (e.g. DVD, Blu-ray, file of choice onto a flash drive, etc.).

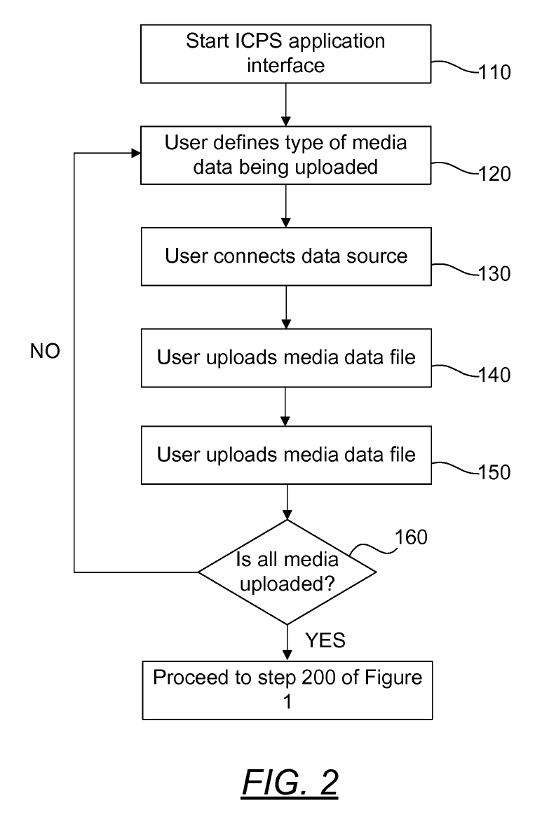

FIG. 2 is a schematic diagram depicting one embodiment of step 100 of FIG. 1. In the embodiment depicted, step 100 of uploading personal content from the User is a multi-step process for User. Referring to FIG. 2 and step 110 thereof, the User initiates the process by opening the ICPS application interface. In step 120, the User is prompted by the ICPS to specify the type of personal content media data being uploaded (text, audio, still images, animation, video, interactivity content forms, and the like). Next, in step 130, the User is prompted to connect to the source of the person content media data to be uploaded by either creating a network connection to stored data or by connecting an external device to the ICPD, placing a photograph on a scanner, etc.

Next, in step 140, the User uploads the personal content media data file. This may be accomplished through any number of methods, for example, copy a file from an external data device, stream data to the ICPD through an external device, or select a data file from a network location. Similarly, User may also directly connect a still image camera, a video camera, or a portable storage device through any number of input ports (e.g. USB, s-video, component, composite, fire wire, and network connection, and the like.) It is also to be appreciated that uploading personal content also contemplates downloading of personal content media data files from the internet. For example, video, audio, or animation data files may be downloaded from a music site such as itunes, Napster, Limewire, Rukus, YouTube, VH1, Sprint Music Store, AnimationFactory, JibJab, and the like. Still images or photographs may be downloaded from a website that processed and stored the User's personal digital photos from his digital camera. Downloading of special effects and other media is also contemplated. These examples are meant to be illustrative but not limiting.

In step 150, the ICPS converts any analog data to digital data via any conventional analog to digital converter. Next, after the personal content media data file has been uploaded, User is prompted, in step 160, to upload the next personal content media data file or to continue on to step 200.

In step 200 of FIG. 1, the uploaded digital data file is stored. Storage of the personal content media data files can either be in RAM or on a disk or disk array. After a personal content media data file is stored, User is prompted to store the next personal content media data file or to continue on to step 300. As will be appreciated by those skilled in the art, this may also be accomplished in a bulk fashion where either selected or all personal content media files are saved in a single step.

Referring again to FIG. 1 and step 300, the User accesses the prerecorded and personal content media data (collectively digital data). The prerecorded data files are file types in the ICPS database similar to the User's personal content media except that the ICPD offers those non-customized media data file choices for any user to include in a final multimedia production. The final multimedia production therefore combines at least one prerecorded data file with at least one personal content data file. Utilizing the ICPS, the User then categorizes the digital data files. The User selects a code from a predesignated list and assigns such code to the file. By way of illustration, the media type may be represented by one or two alphabetical characters:
C—Caption
TS—Text to Speech
I—Image
S—Sound

This media type designation may be selected by the User or assigned by the ICPD upon recognition of the file type.

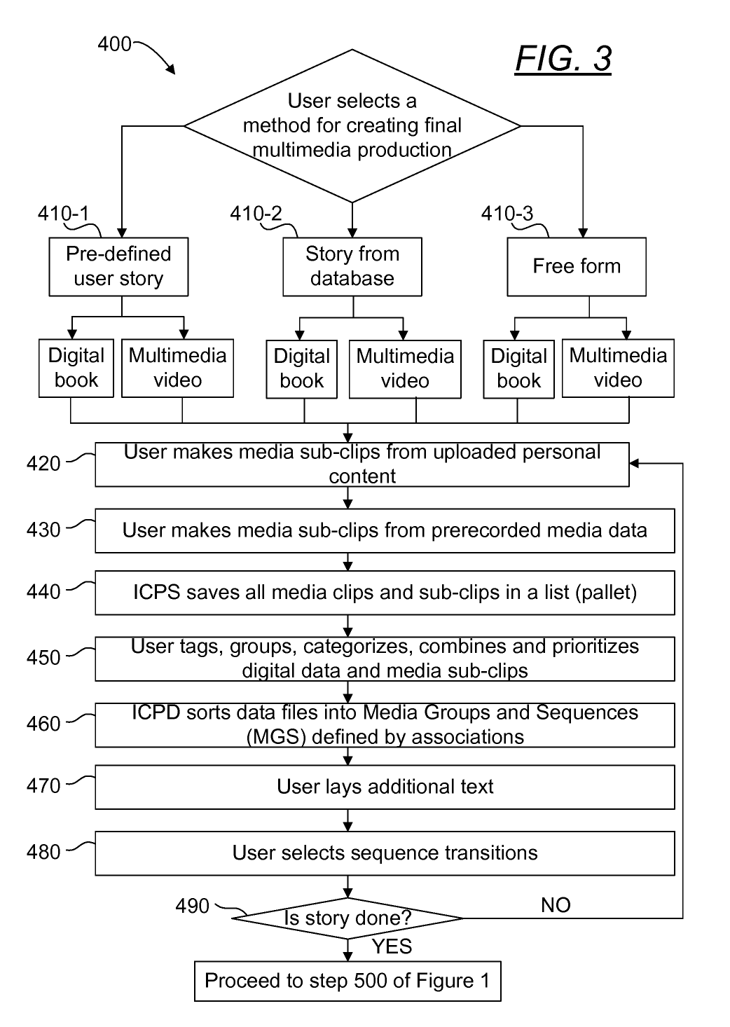

FIG. 3 is a schematic diagram depicting one embodiment of step 400 of FIG. 1 where the digital data is processed (thereby creating processed digital data). User may assemble a final multimedia production from one or more media clips. As previously described, these media clips may originate from a selection of prerecorded media in the ICPD database, media from the user uploaded into the ICPD or media downloaded from the internet into the ICPD.

In step 410 of FIG. 3, the User selects a method for creating a final multimedia production. The User chooses to create a final multimedia production (1) entirely made up of the personal content digital data files utilizing a standard multimedia opening and/or closing sequence (option 410-1); (2) an impersonalized, prerecorded and previously stored multimedia production from a pallet of multimedia productions (stored in a database on the ICPD), to be personalized by combining the prerecorded digital data with the personal content digital data files (option 410-2); or (3) a “free form” method of creation by utilizing a standard multimedia opening and/or closing sequence and directly inputs text, via the ICPH, to combine with the personal content digital data files (option 410-3). In all choices, User is able to add additional personal content or personalization.

After User has chosen the method for creating the multimedia production, User will be prompted to choose the multimedia format of the final product. User can choose the multimedia digital “book” format or the multimedia digital video format for any of the 410 choices (410-1, 410-2, 410-3).

User may choose a multimedia digital video format which consists of a continuous multimedia video stream that may contain text, audio, still images, animation, video and/or special effects. User may also choose a non-continuous multimedia digital “book” format that will prompt the viewer to continue through the multimedia production by physically turning a page or digitally selecting advancement. The non-continuous book form may contain text, audio, still images, animation, video and/or special effects.

Referring again to FIG. 3, User therefore makes a selection from among the following combinations:
410-1-digital book—a multimedia production entirely made up of the personal content digital data files utilizing a standard multimedia opening and/or closing sequence to produce a digital book, a non-continuous format, multimedia production;
410-1-digital video—a multimedia production entirely made up of the personal content digital data files utilizing a standard multimedia opening and/or closing sequence to produce a continuous format digital video multimedia production;
410-2-digital book—an impersonalized, prerecorded and previously stored, multimedia production from a pallet of multimedia productions (stored in a database on the ICPD), to be personalized by combining the prerecorded digital data with the personal content digital data files to produce a digital book, a non-continuous format, multimedia production;
410-2-digital video—an impersonalized, prerecorded and previously stored, multimedia production from a pallet of multimedia productions (stored in a database on the ICPD), to be personalized by combining the prerecorded digital data with the personal content digital data files to produce a continuous format digital video multimedia production;
410-3-digital book—a “free form” creation method by utilizing a standard multimedia opening and/or closing sequence and directly inputs text, via the ICPH, to combine with the personal content digital data files to produce a digital book, a non-continuous format, multimedia production; or
410-3-digital video—a “free form” creation method by utilizing a standard multimedia opening and/or closing sequence and directly inputs text, via the ICPH, to combine with the personal content digital data files to produce a continuous format digital video multimedia production.

If User chooses the 410-1 user created option, an uploaded text file is selected by User and he proceeds to linearly arrange the story text. The User will then be prompted to define any breaks if the story is going to be in a non-continuous multimedia digital book format.

If User chooses the 410-2 prerecorded option, the impersonalized, prerecorded and previously stored, multimedia production will be loaded with predefined breaks if the story is in a non-continuous multimedia digital book format.

If User chooses the 410-3 “free form” option, only the opening or closing sequence will be loaded and User will define breaks as he progress through the story.

Referring again to FIG. 3, User is prompted to optionally create media sub-clips from any of the digital media data, in step 420. User utilizes the ICPS to create personal media sub-clips from the personal content digital data by selecting starting points and ending points within any of the personal content digital data files and saving the personal content digital data media sub-clips. The same process is optionally followed for the prerecorded data in step 430.

In step 440, the ICPD saves all media sub-clips and digital data (personal content and prerecorded) in a list. Next, in step 450, User is prompted to group, categorize and combine any of the digital data or media sub-clips with each other to create a Media Group or Sequence (MGS) (any combination of text, audio, still images, animation, and/or video.) As used in this specification, Media Group or Sequence (MGS) means any combination of individual media data files (including sub-clips) combined to form a new multimedia group or sequence. The basic algorithm for the creation of MGS is described below.

A list is a “pallet” of media clips and sub-clips that comprises the pool of files uploaded, downloaded, prerecorded, and created through sub-clipping, and stored in the storage device. This pallet of media clips and sub-clips are those digital data files that potentially can become a part of the final multimedia product. These digital data files can be audio, video, graphic (still image or photographs or artwork images), animation, text or other file types as desired by User.

The ICPS allows the User to select and run a file from the pallet to view. If User desires to use a particular file, it is selected to be tagged. The User has previously selected and assigned a code to each file. Thus, by way of illustration, a list containing 16 files that have been selected by User for inclusion in the final multimedia product might be represented as follows:
File 1 (C)
File 2 (TS)
File 3 (I)
File 4 (S)
File 5 (C)
File 6 (TS)
File 7 (I)
File 8 (S)
File 9 (C)
File 10 (TS)
File 11 (I)
File 12 (S)
File 13 (C)
File 14 (TS)
File 15 (I)
File 16 (S)

Tagging further involves specifying the MGS group of a file and specifying the priority of a file. In one embodiment, an MGS group is represented numerically. By way of illustration, MGS group 1 represents beach scenes, MGS group 2 represents birthday parties, MGS group 3 represents a baseball game and MGS group 4 represents vacation scenes.

Priority can be represented by a second numerical character from 1 to 5. A higher priority clip is displayed earlier than a lower priority clip. Two files of the same priority may be displayed in the order in which they are processed or they may be displayed randomly.

A tag then comprises one or two alphabetic characters to represent media file type, followed by one numeric character to represent an MGS group, followed by one numeric character to represent priority within the MGS group.

MGS grouping enables one to quickly identify files of similar nature, for example, beach scenes, birthday parties, etc. An MGS group can also contain commonly used files so that it can be used in more than one scene.

By way of illustration, the 16 files previously selected may be tagged as follows:
File 1 is tagged C11
File 2 is tagged TS22
File 3 is tagged I33
File 4 is tagged S12
File 5 is tagged C22
File 6 is tagged TS33
File 7 is tagged 122
File 8 is tagged S11
File 9 is tagged C11
File 10 is tagged TS23
File 11 is tagged I34
File 12 is tagged S23
File 13 is tagged C41
File 14 is tagged TS42
File 15 is tagged I43
File 16 is tagged S44

Once the file is assigned a code, it is stored in a second list, often referred to as a pallet. The User can view the pallet and create associations between the files. Next, the User associates files in groupings for presentation in the final multimedia production. Files of the same Multimedia Group or Sequence (MGS) group are grouped together.

By way of illustration, User may create an association between a picture file and an audio file (for example, to play background music during the viewing of certain photographs) or a video file and a text file (for example, to create captioning). Noncompatible files will not be capable of association. For example, if a video file has an audio clip and the ICPD does not provide for synchronization of a separate audio file, an association between a video file and an audio file will not be permitted.

Thus, the 16 files previously described may be associated as follows:
Association 1: File1C11-File4S12-File8S11-File9C11—File16S44
Association 2: File2TS22-File5C22-File7I22-File10TS23-File12I23—File15I43
Association 3: File3I33-File6TS33-File11I34—FileS44-FileTS42

File 13C41 is not associated with any files. In Association 1, there are 5 files with 2 types of clips.

Once a MGS has been created and saved, the User will be prompted to continue to combine any of the data files to form additional MGSs or choose to continue on to step 460. After a first association is created for a particular file, the ICPS will prompt the User by asking if more associations are desired for the selected file, allowing the User to make as many associations as there are additional files in the list. Once the User responds negatively that no additional associations are desired for the selected file, the ICPS will do the same routine for the next file on the list until all associations desired by the User for all of the files have been input. For each file, the User can associate every other file but cannot associate a file with itself. The ICPS will prompt the User to create associations for all files that have not previously been assigned an association but will allow for the option of not creating an association for any individual file.

Referring again to FIG. 3 and step 460, once the list has been concluded, the ICPD sorts the files. The ICPD will sort the list into MGS groups defined by the associations.

In the final multimedia production, media clips of different types can be synchronized to play simultaneously. For example, a caption media clip can be displayed while a sound media clip is played. The show ends when the longest media clip ends.

In cases where there are the same types of media clips, the ICPD determines which media clip plays first. Referring to our example again, in Association 1, there are 2 types of media clips. The S type has 3 files of the priority of 2, 1 and 4. The algorithm will play the files in the following order: the S type media clip with priority “1” will play first followed by “2” and then “4”. The C media clips of the same priority (“1”) are played randomly according to the priority created by a random number generator. The different types of media clips are merged such that the static media clips play an equal duration of time over the combined total span of the dynamic content media clip. Referring again to our example, File 4, File 8 and File 16 take a predetermined total of X seconds to complete. File 1 and File 9 will be displayed for X/2 seconds each.

Referring again to our example and Association 2, there are three types of clips: TS, C, and I. TS22 goes before TS23, I22 goes before I23 and I23 goes before I43. The TS clips are dynamic content. In this example, the dynamic TS media clips determine the span of the story. If File 2 and File 10 play a total of Y seconds, then File 5, File 7, File 12 and File 15 play a combined total of Y seconds.

In step 470, User layers additional text by inputting text interactively or selecting text from prerecorded text files. User selects the way the text, audio, still images, animation, video, Media Group, and/or special effects are to be laid out, displayed, and layered.

In step 480, User selects transitions from one sequence to another until the story is completed and a final multimedia production is assembled. User may be prompted for selection text, audio, still images, animation, video, Media Group, and/or special effects at various points throughout the story.

In step 490, User reviews and edits the multimedia product and chooses to continue to edit or proceed. Once User has decided the multimedia product is finished, they will proceed to steps 500 and 600 to output and save the final multimedia production.

Referring again to FIG. 1, in step 500 the processed digital data (final multimedia production) is output. Thus far up, to and including step 500, is comprised of inputting and storing a plurality of individual media types, followed by accessing, arranging, and editing the files in preparation for final processing creating a final file compatible with predetermined storage media. User chooses the output format of their final multimedia production, most often a digital file to be saved in step 600 and burned or stored onto a media type such as a DVD, CD, Blu-ray disk, MP3-player, MP4-player or other type of digital compatible media. In one embodiment, User may also select a paper book that contains interactive buttons to be pushed to produce audio from digital audio clips.

Next, in step 600, the final multimedia production output file is stored in the ICPD or on a portable media format selected in step 500. This may be accomplished through any number of methods, for example, copy a file to an external data device, stream data from the ICPD to an external device, or select a storage device from a network location. Similarly, User may also directly connect a still image camera, a video camera, or a portable storage device through any number of output ports (e.g. USB, s-video, component, composite, fire wire, and network connection, and the like.) It is also to be appreciated that saving and storing the final multimedia production also contemplates uploading to a website on the internet.

It will be recognized by one skilled in the art that these operations, structural devices, and acts may be implemented in software, in firmware, in special purpose digital logic, and any combination thereof without deviating from the spirit and scope of the present invention.

### Information Content Processing Device

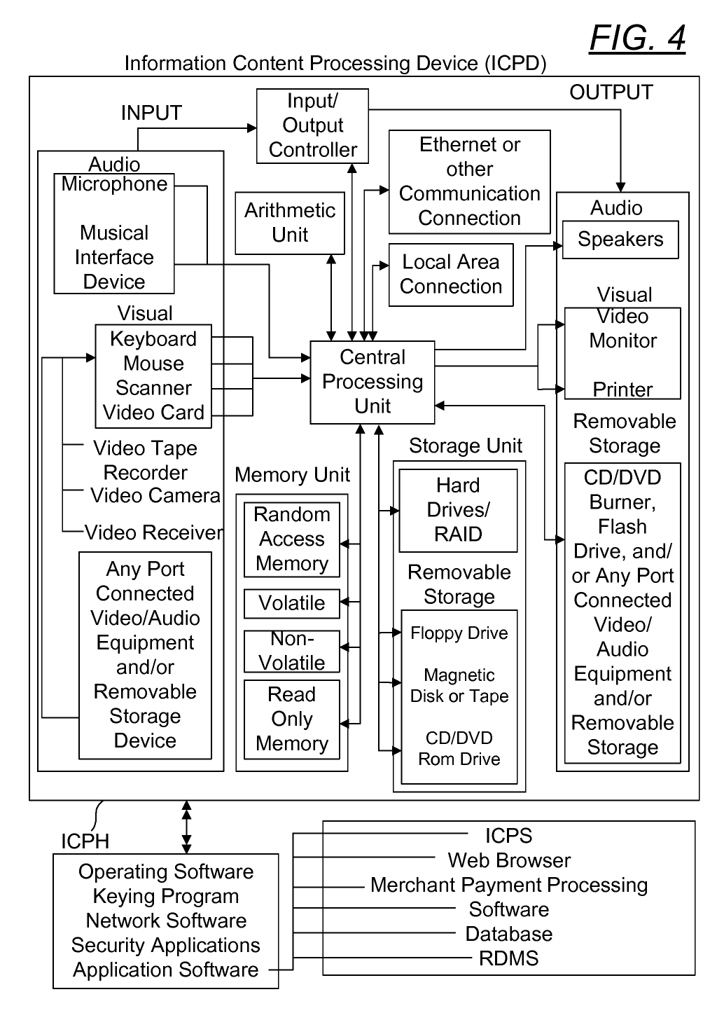

FIG. 4 illustrates one embodiment of the Information Content Processing Device. In a basic configuration, an ICPD includes at least one central processing unit (CPU), memory unit, and a storage unit. Depending on the exact configuration and type of the ICPD, the memory unit may be volatile (such as RAM), non-volatile (such as ROM, flash memory, etc.) or some combination of the two.

In the embodiment depicted in FIG. 4, an ICPD, that can also be described as a multimedia computer or workstation system that includes at least one central processing unit (CPU), volatile and non-volatile system memory in a memory unit, removable and nonremovable storage (storage unit), input devices, output devices, and communications connections (ethernet or other communication connection and local area connection). Software of the ICPD depicted includes operating software, keying program, networking software, security software, and applications software. Applications software includes ICPS, web browser, RDMS, a database and merchant payment processing software. Additionally, a variety of software to handle the multitude of formats associated with graphics, photographs, video, audio, etc. must be available. The function that the software will be required to perform on the inputted files includes: transcoding, transrating, transsizing, re-encoding, compressing, error compensating, editing, etc. The situation is further complicated by capacity limits of the media type where the final product resides, the type and characteristics (e.g. DVD region code, PAL or NTSC, etc.) of the playback equipment that the final product is to be played on, the viewing device (e.g. standard or HD monitor), and so forth. It should be appreciated that one or more of the preceding data and program modules may also reside on the memory of remote computers and interface with the ICPD via the network or the internet via a communications device and protocol to, for example, a MEF (Media Expert Facility).

Any operating system suitable for controlling the operation of a networked personal or server computer may be incorporated in the ICPD. The ICPD also includes a database for storing relationships defined by the User and drawn between media categories for use in generating a personalized multimedia product. Still further, the ICPD may include a database of prerecorded graphic, text, picture, animation, audio and/or video data, and a relational database management system (RDMS).

The ICPD nonremovable storage unit is connected to the CPU through a mass storage controller connected to the system bus. The removable and non removable storage unit provides non-volatile storage for the ICPD. The non removable storage unit may be one or more hard drives or several hard drives arranged and configured in a RAID array.

The CPU may store data to and access data from the storage devices. Data is transferred to and received from the storage devices. The CPU may be a general purpose processor, but preferably a high end model, since the processing of large media files often requires a significant amount of computing power to accomplish. Additional methods of enhancing the computer system's or workstation's computing power includes the use of motherboards designed to utilize more than one CPU, the use of multi-core CPUS, and the like.

According to various embodiments of the invention, the computing apparatus can operate in a networked environment, using communications and/or logical connections to remote computing devices via network communication, such as an Intranet, or a local area network (LAN) or wide area network (WAN). The ICPD may connect to a network via an Ethernet or other communication connection and/or local area connection. It should be appreciated that the network interface unit may also be utilized to connect to other types of networks and remote computer systems.

The ICPD also includes an input/output controller for receiving and processing input from a number of input devices, including a keyboard, touchscreen, remote control, keypad, RFD receiver, infrared receiver, or port configured to receive data from an external communications or storage device. Similarly, the input/output controller provides output to output devices such as a display screen, a printer, a writable CD drive, writable DVD drive, RFD transmitter, infrared transmitter, and/or port configured to send data to an external communications or storage device or other type of output device.

An ICPD further includes at least some form of computer-readable media. Computer readable media can be any available media that can be accessed by the ICPD such as computer storage media and communication media. Computer storage media includes volatile and nonvolatile, removable and non-removable media implemented in any method or technology for storage of information such as computer readable instructions, data structures, program modules or other data.

Computer storage media includes, but is not limited to, RAM, disk drives, a collection of disk drives (JBOD), RAID array, memory cards, flash memory, other memory technology or any other medium that can be used to store the desired information and that can be accessed by the ICPD.

Communication connections connect the ICPD to communications media which typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF, infrared, blue tooth and other wireless media. Combinations of any of the above should also be included within the scope of computer-readable media.

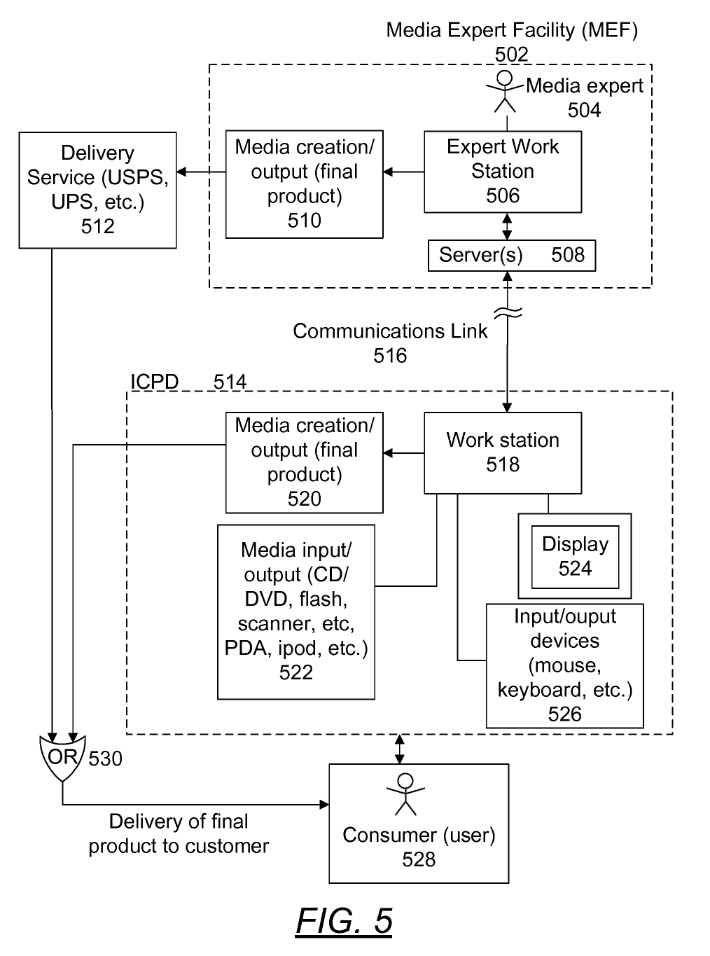

FIG. 5 illustrates another embodiment showing the relationships among the MEF, Media Expert, ICPD, Delivery Service, and the User. In this embodiment, User 528 and ICPD 514 are connected via Communications Link 516 to a MEF (Media Support Facility) 502 having an available Media Expert 504 present. Such an embodiment enables inexperienced users (unfamiliar with the multitude file formats associated with a multimedia production) or users with complex projects the ability to receive real time assistance at ICPD 514 site, in addition to having the project optionally uploaded to MEF 502 for accelerated professional processing. Following the completion of such processing at Media Creation Output 510 stage at MEF 502 site, User 528 can request media containing final product to be delivered via Delivery Service 512 (e.g. UPS, USPS, etc.), or the final file containing the completed multimedia production to be downloaded to the ICPD 514 site for burning or storing the final file on to the desired media at the Media Creation Output 520 stage. Because of the multitude of possible file formats presently associated with a multimedia production (and the addition of new ones with advancing technology) an Expert Media Facility 502 service ensures successful completion of complex projects leading to a positive customer experience.

Media Expert 504 is an individual(s) that is well trained the art of multimedia manipulations that has quick access to numerous helps to quickly diagnose a problem and initiate a remedy. Helps include bookmarked media-help sites, books, manuals, other experts, and the like. Media Expert 504 has a vast array of software available at their disposal to enable processing of common as well as less common media requests. Additionally, Media Expert 504 in a preferred embodiment possesses the means and the authority to immediately purchase necessary software (via internet) to complete a job request.

User 528 and ICPD 514 are connected to a MEF (Media Support Facility) 502 via Communications Link 516. Communications Link 516 is preferably a high speed or broadband internet connection (e.g. DSL, T-1/DS-1, DS-3, OC-3, OC-192, OC-3072, etc.) since media files are typically very large in size.

The Expert Work Station 506 and associated optional server(s) 508 is preferably a computing system designed to quickly and efficiently process large multimedia files. Optional server(s) 508 function to buffer and protect Expert Work Station 506 from Communications Link 516, coordinate jobs with associated files, store completed files, and the like. Such workstations achieve advanced computing power through a variety of means including the use of motherboards designed to utilize more than one CPU, utilizing multi-core CPUs, and the like. The Expert Work Station 506 and associated optional server(s) 508 has the ability to serve the requests of several ICPD 514 sites, enabling the higher priced system to serve the less equipped Work Stations 518 providing not only a cost reduced overall system, but one that handle foreseeable complex multimedia issues. It is understood that any number of Expert Work Stations 506, and Media Experts 504 can be housed at MEF 502 site to meet the needs of the system's ICPD 514.

ICPD 514 systems can be located in generic retail stores, electronics outlets, college campuses, print shops, etc. in the form of a kiosk or the like. User 528, would approach ICPD 514 system and start the process solo, or can request assistance of the support staff (common at some high-end retail shops). A personal computing system and communications link can act as an ICPD 514 site if the personal computing system has sufficient capability, enabling office or home use options. Depending on User 528 needs a combination of services can be obtained between the ICPD 514 system and MEF 502 sites. One such service involving physical media is depicted as OR 530 function block in FIG.5, where options include, immediately obtaining a first copy of the final multimedia production from Media Creation/Output 520 and ordering additional copies from MEF 502 site through Delivery Service 512, or obtaining final media copies solely through the MEF 502 site or from the ICPD 514 system. The final file containing the completed multimedia production can also be stored on Expert Work Station 506, Server(s) 508, as well as Work Station 518 for future processing, or remote viewing via Communications Link 516 utilizing internet access, data streaming, and the like.

### Computer Program

The computer program product embodying the ICPS and the MEF Expert Work Station and computer process method aforementioned may be a computer storage media readable by a computer system and encoding a computer program of instructions for executing a computer process. The computer program product may also be a propagated signal on a carrier readable by a computing system and encoding a computer program of instructions for executing a computer process. Software providing the means for transforming files includes those enabling: transcoding, transrating, trans-sizing, re-encoding, compressing, error compensating, editing, etc.

Having substantially described the invention, it is understood that the scope of the invention is not limited by the preceding specification, but by the appended claims.

What is claimed herein:

1. A method for producing a multimedia production using an Information Content Processing Device (ICPD), comprising the steps of:
obtaining the individual media types to create the multimedia production,
selecting the final media type and format on a user interface,
inputting and storing a plurality of individual media types into said ICPD via said interface,
accessing, arranging, and editing individual media files into a multimedia composition,
processing the digital data, comprising reviewing the said multimedia composition.

2. The method of claim 1 wherein said processing step further comprises writing said multimedia composition on a predetermined media type and format at substantially the same location as said ICPD and said user.

3. The method of claim 1 wherein said processing step further comprises a communications link from said ICPD to a Media Expert Facility (MEF) for transmitting and storing said multimedia composition to an expert work station, whereby enabling a media expert to analyze said multimedia composition.

4. The method of claim 3 wherein said processing step further comprises said media expert communicating in real-time with a user, collocated with said ICPD, whereby said user receives assistance from said Media Expert.

5. The method of claim 3 wherein said processing step further comprises finalizing and storing said multimedia composition to a final digital state ready for delivery to a predetermined media type.

6. The method of claim 3 wherein said processing step further comprises writing said multimedia composition on a predetermined media type and format at said Media Expert Facility under the direction of said Media Expert.

7. The method of claim 6 wherein said processing step further comprises delivering said media to user.

8. The method of claim 5 wherein said processing step further comprises transmitting, via said communications link, and storing said final digital state multimedia composition to ICPD, whereby said final digital state multimedia composition is local to said user.

9. The method of claim 8 further comprising writing said final digital state multimedia composition onto a predetermined media type and format.

10. A method for producing a multimedia production using an Information Content Processing Device (ICPD) and a Media Expert Facility (MEF), comprising the steps of:
obtaining the individual media types to create the multimedia production,
selecting the final media type and format on a user interface located on said ICPD,
inputting and storing a plurality of individual media types into said ICPD, using said
interface,
accessing, arranging, and editing individual media types into a multimedia composition,
processing the digital data, comprising reviewing the said multimedia composition,
transmitting said multimedia composition to a Media Expert Facility (MEF),
finalizing said multimedia composition to a final digital state ready for writing to a predetermined media type and storing composition thereof.

11. The method of claim 10 further comprising transmitting and storing said final digital state multimedia composition, via said communications link, to ICPD, whereby said final digital state multimedia composition is local to said user.

12. The method of claim 10 further comprising writing said final digital state multimedia composition onto a predetermined media type and format, whereby final product is local to said user.

13. A system for producing a multimedia production using an Information Content Processing Device (ICPD), and Media Expert Facility (MEF), comprising:
means for inputting and storing a plurality of individual media types into said ICPD
enabling user to compile individual files,
means for accessing, arranging, and editing individual media files into a multimedia
composition,
means for processing the digital data, enabling reviewing said multimedia composition.

14. A system for producing a multimedia production of claim 13 wherein means for processing further comprises a means for writing said multimedia composition onto a predetermined media type.

15. A system for producing a multimedia production of claim 13 wherein means for processing further comprises a means for transmitting and storing said multimedia composition to a Media Expert Facility (MEF).

16. A system for producing a multimedia production of claim 15 further comprising a means for analysis of said multimedia composition by a Media Expert, whereby providing a final digital state multimedia composition.

17. A system for producing a multimedia production of claim 16 further comprising a means for writing said final digital state multimedia composition onto a predetermined media type.

18. A system for producing a multimedia production of claim 17 further comprising a means for delivering said predetermined media type to a consumer.

19. A system for producing a multimedia production of claim 16 further comprising a means for transmitting said final digital state multimedia composition to said Information Content Processing Device (ICPD).

20. A system for producing a multimedia production of claim 19 further comprising a means for writing said final digital state multimedia composition onto a predetermined media type.
